(19) United States
(12) Patent Application Publication
(10) Pub. No.: US 2012/0052468 A1
(43) Pub. Date: Mar. 1, 2012

(54) METHODS AND SYSTEMS FOR PREPARATION OF TREATMENT PLANS

(76) Inventor: Doreen Granpeesheh, Woodland Hills, CA (US)

(21) Appl. No.: 12/874,159

(22) Filed: Sep. 1, 2010

(51) Int. Cl. G09B 19/00

(52) U.S. Cl. 434/236

(57) ABSTRACT

A program module is configured with sub-modules for child development assessment, presentation of progress charts and development of individualized treatment plans. An assessment sub-module includes assessment tools for behavioral educators of children with developmental disorders to identify mastered and non-mastered skills of a subject child. A treatment plan sub-module is configured to permit the behavioral educator to determine a set of lessons from a curriculum, which lessons define an individualized, Applied Behavior Analysis (ABA)-based program of instruction based on the needs of a subject child as identified by the assessment tools. A progress chart sub-module is configured to permit monitoring of the subject child's progress as the subject child progresses through the lessons of the individualized program under the guidance of one or more instructors.

### FIELD OF THE INVENTION

The present invention relates to computer-based methods and systems for providing behavioral educators of children with developmental disorders: (a) training in Applied Behavior Analysis (ABA) and how it is used to teach skills to said children, (b) on-line assessment tools to identify mastered and non-mastered skills of said children, and (c) automatically generated and individualized ABA-based programs of instruction based on the needs of said children as identified through use of the assessment took.

### BACKGROUND

Applied behavior analysis (ABA) can be regarded as the application of behaviorism, the study of human behavior, to affect, enhance or eliminate a particular behavior in an individual. ABA has been used in connection with a variety of activities, including teaching children with developmental disorders, such as autism. ABA is not, however, a specific, program or curriculum for teaching an autistic child desired skills, rather, it is a framework for understanding how an appropriate program can be developed.

Prior attempts to develop individualized lesson plans for teaching skills to children with developmental disabilities have suffered from a lack of correlation between skill assessment and teaching curriculum. For example, such solutions may provide for accurate skill assessments, but then fail to directly link the assessment results to lesson plans. In other instances, well-developed curricula may not be connected with assessment tools that have items directly linked to each lesson plan within the curriculum.

The few skill development curricula that do exist generally do not provide any suggestions for the order in which skills should be taught. Nor are the skills segregated by age. Even where assessment tools and curricula are combined, they are generally not comprehensive and tend not to encompass executive functions or cognition. Those areas for which curricula are available are often treated generically, or, even if treated at a more granular level, are often missing important targets within each lesson that make up the curriculum.

### SUMMARY OF THE INVENTION

In various embodiments, the present invention provides a computer-based system, e.g., a server or other system, which includes a processor and a storage medium communicatively coupled thereto. The storage medium stores computer-executable instructions, which when executed by the processor cause the processor to execute a program module configured with sub-modules for child development assessment, presentation of progress charts and development of individualized treatment plans. For example, an assessment sub-module includes assessment tools for behavioral educators of children with developmental disorders to identify mastered and non-mastered skills of a subject child. A treatment plan sub-module is configured to permit the behavioral educator to determine a set of lessons from a curriculum, which lessons define an individualized, Applied Behavior Analysis (ABA)-based program of instruction based on the needs of a subject child as identified by the assessment tools. A progress chart sub-module is configured to permit monitoring of the subject child's progress as the subject child progresses through the lessons of the individualized program under the guidance of one or more instructors.

The assessment tools may be configured as a question and answer interchange mechanism configured to permit evaluation of the subject child's existing skills, identifying strengths and deficits that require intervention. Through the answers provided via the assessment tool, skill deficits of the subject child are identified, and tasks are generated and placed automatically within a task list of a treatment plan. The question and answer interchange mechanism may include a preliminary series of exclusionary questions designed to determine whether or not the subject child can perform basic skills, a screening process designed to obtain information concerning the subject child's current abilities with respect to a number of age-appropriate lessons, and a detailed set of skill assessment questions tailored to further determine skill deficits of the subject child not specifically identified during the screening process. The skill assessment questions may be organized by skill area and are presented to a user in chronological order of child development across a plurality of domains, for example, language, play, adaptive, motor, executive functions, cognition, social, and academic skills. The skills assessment questions may be presented to a user in a hierarchical fashion, by lesson name, then lesson area, then question type. A “yes” answer to a skills assessment question directed to a fundamental skill within a lesson area may, in some instances, automatically populate “yes” answers to any questions directed to prerequisite skills for the fundamental skill, however, a “no” answer to the fundamental skill may automatically populate “no” answers to questions directed to other skills that require the fundamental skill in order to be performed. In some instances, a “probe” answer may be used as a way to save the question to a temporary database table, so that, at a later time, a more detailed analysis of the question can be performed for getting the correct yes or no answer that might not be apparent when the question is first presented.

The program module may also be configured to produce reports based on answers to assessment questions identifying skills that are in the subject child's repertoire versus those that need to be taught. Such reports are preferably configured to be age-relevant and summarized according to skills that the subject child's same-age peers would exhibit.

In some instances, the treatment plan sub-module is configured to develop an individualized program of instruction to teach the subject child skills identified as being absent from the subject child's repertoire according to answers to skill assessment questions. The skill assessment questions are based on particular skills the subject child should exhibit for each lesson area, and each of the skills assessment questions are tailored to particular discriminative stimulus (S^{D}) and/or establishing operations (EO) of a respective one of a plurality of lessons of the individualized program of instruction. The individualized program of instruction may be developed according to user selections from a domain-sorted list of lessons deemed necessary for the subject child, based on answers to skill assessment questions received via the assessment sub-module.

A detailed treatment plan developed according to individual lessons selected for inclusion in the individualized program of instruction may be provided. Preferably, the detailed treatment plan will include lessons from one or more selected lesson areas and will be segregated, along a first treatment plan axis, into levels. Each lesson area may also be segregated, along a second treatment plan axis, into individual skills. Each skill of a lesson area has at least one corresponding skill assessment question, and each subject skill of each lesson area may be coded according to whether or not the subject child has already mastered the subject skill, and by age.

### BRIEF DESCRIPTION OF THE DRAWINGS

The present invention is illustrated by way of example, and not limitation, in the figures of the accompanying drawings in which:

FIG. 1 illustrates an example of a computer network in which embodiments of the present invention may find application and use;

FIG. 2 illustrates an example of a computer system suitable for configuration in accordance with embodiments of the present invention;

FIG. 3 illustrates a software architecture of a computer system configured in accordance with an embodiment of the present invention;

FIG. 4 illustrates an overview of a server-based application configured in accordance with an embodiment of the present invention;

FIG. 5 illustrates an example of a web form configured for use in a screening process in accordance with an embodiment of the present invention:

FIG. 6 illustrates an example of a user interface for the presentation of skill assessment questions and obtaining responses thereto in accordance with an embodiment of the present invention;

FIG. 7 illustrates an example of a user interface for building a treatment plan in accordance with an embodiment of the present invention;

FIG. 8 illustrates additional aspects of a user interface for building a treatment plan in accordance with an embodiment of the present invention;

FIG. 9 illustrates still a further aspect of a user interface for building a treatment plan in accordance with an embodiment of the present invention;

FIG. 10 illustrates an example of a detailed treatment plan prepared in accordance with an embodiment of the present invention; and

FIG. 11 illustrates aspects of a treatment progress a constructed in accordance with an embodiment of the present invention.

### DETAILED DESCRIPTION

Described herein are computer-based methods and systems for providing behavioral educators of individuals (e.g., children) with developmental disorders: (a) training in ABA and how it is used to teach skills to said children, (b) assessment tools to identify mastered and non-mastered skills of said individuals, and (c) automatically generated and individualized ABA-based programs of instruction based on the needs of said individuals as identified through use of the assessment tools. In various embodiments of the invention, the training aids, assessment tools and individualized programs are made available through a Web portal or other computer-based resource (such as a client computer system), accessible to educators, therapists, parents, physicians, and others involved with the subject children for which the programs are intended. The portal allows for access to on-line training modules, an assessment tool comprised of a series of exclusionary questions that the behavioral educator answers about the subject child, and individualized programs, determined as a result of the answers to the assessment questions, that can be used by the behavioral educator to teach identified skills to the child. The curriculum from which the programs are derived includes eight different areas: language, play, adaptive, motor, executive functions, cognition, social, and academic skills, and each program is composed of lessons developed to give the behavioral educator examples of specific concepts that should be taught. Thus, the present invention provides age-appropriate, comprehensive ABA-based programs for children with developmental disabilities.

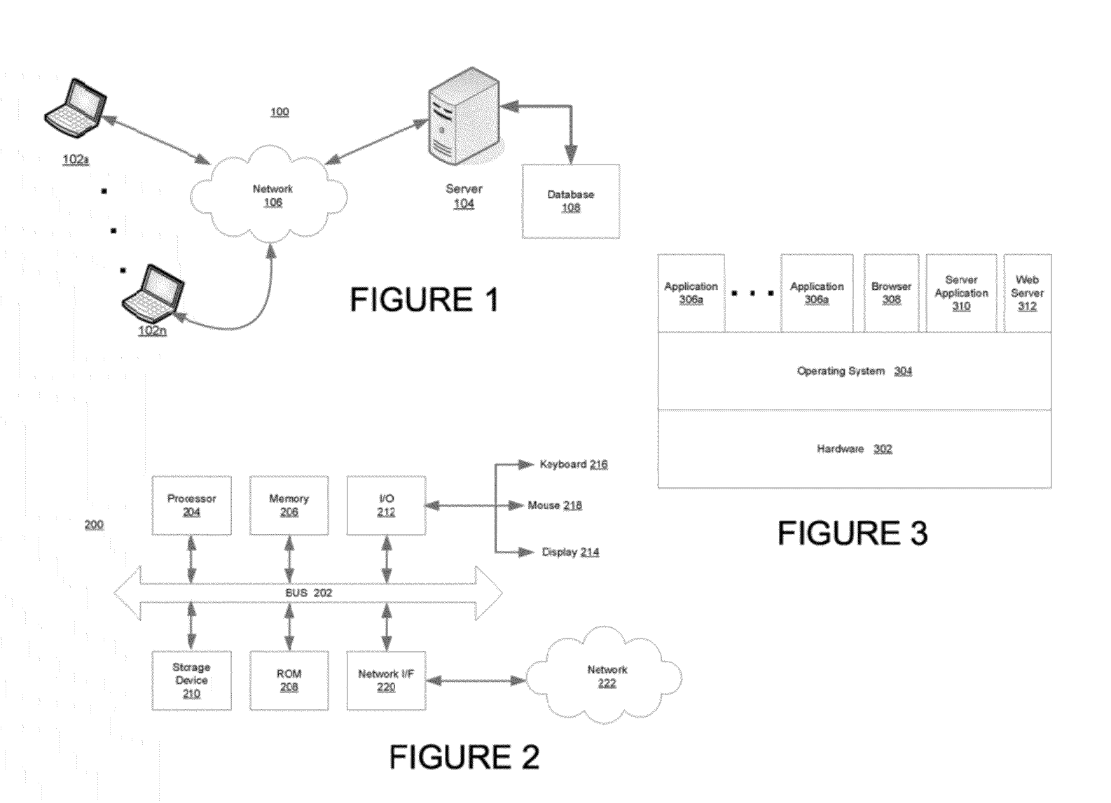

Before describing aspects of the present invention in detail, it is helpful to first discuss the environment in which embodiments of the invention operate. FIG. 1 is a simplified illustration of a computer network 100 which is such an environment. Network 100 includes one or more client computer systems 102a-102n, which may be used by educators and others seeking to access a server 104 at which an instantiation of a computer-based application which provides the features discussed above may be installed and accessible. Such access may be a computer network or network of networks 106, such as a local and/or wide area network. In some cases, network 106 may be or include the network of networks commonly known as the Internet. In other instances, network 106 may be a local area network (LAN) of an enterprise and/or a virtual LAN which is instantiated over the Internet or other networks of networks. Server 104 is communicatively coupled to a database 108, which may store records concerning children for which curricula have been developed and other information as described further below. Client computers 102a-102n may be any form of computer-bases system, including personal computers, laptop computers, net book computers, mobile devices, smart phones, and the like. Generally, a client computer 102 will run a Web browser application, through which the application running on server 104 may be accessed, however, in some instances, client computers 102 may run a client application specially configured to interface with the application running on server 104.

FIG. 2 is a block diagram illustrating an example of a computer system 200. Any of client computer systems 102a-102n and/or server 104 may be configured in the manner described for computer system 200.

Computer system 200 includes a bus 202 or other communication mechanism for communicating information, and a processor 204 coupled with the bus 202 for processing information. Computer system 200 also includes a main memory 206, such as a random access memory (RAM) or other dynamic storage device, coupled to the bus 202 for storing information and instructions to be executed by processor 204. Main memory 206 also may be used for storing temporary variables or other intermediate information during execution of instructions to be executed by processor 204. Computer system 200 further includes a read only memory (ROM) 208 or other static storage device coupled to the bus 202 for storing static information and instructions for the processor 204. A computer-readable storage device 210, such as a magnetic disk or optical disk, is provided and coupled to the bus 202 for storing information and instructions.

Computer system 200 may be coupled via the bus 202, either directly or via an input/output module 212, to a display 214, such as a flat panel display, for displaying information to a computer user. An input device 216, including alphanumeric and other keys, is coupled to the bus 202 for communicating information and command selections to the processor 204. Another type of user input device is cursor controller 218, such as a mouse, a trackball, or cursor direction keys for communicating direction information and command selections to processor 204 and for controlling cursor movement on the display 214.

As should be apparent, aspects of the present invention involve computer software running on server 104. That software may take the form of computer-executable instructions stored in main memory 206 and/or storage device 210, to be executed by processor 204. In other instances, the instructions may be stored on other computer-readable media, such as a floppy disk, a flexible disk, a hard disk, magnetic tape, or any other magnetic medium, a CD-ROM or DVD-ROM, flash memory, or any other physical medium adapted to store computer-readable instruction and from which a computer processor can read. Execution of the sequences of instructions contained in the main memory 206 causes the processor 204 to perform the processes described herein to provide training materials, on-line assessment tools, and/or individualized curricula. In alternative embodiments, hard-wired circuitry may be used in place of or in combination with computer software instructions to implement the invention. Thus, embodiments of the invention are not limited to any specific combination of hardware circuitry and software.

The algorithms and processes presented herein may be implemented in hard-wired circuitry, by specially programming a general-purpose computer system or by any combination of hardware and software. One of ordinary skill in the art will immediately appreciate that the invention can be practiced with computer system configurations other than those described above, including hand-held devices, multiprocessor systems, microprocessor-based or programmable consumer electronics, digital signal processor-based devices, personal computers, minicomputers, mainframe computers, etc. The invention can also be practiced in distributed computing environments where tasks are performed by remote processing devices that are linked through a communications network. Unless specifically stated otherwise, it will be appreciated that throughout the description of the present invention, use of terms such as “processing”, “computing”, “calculating”, “determining”, “displaying” or the like, refer to the action and processes of a computer system, or similar electronic computing device, that manipulates and transforms data represented as physical (electronic) quantities within the computer systems registers and memories into other data similarly represented as physical quantities within the computer system memories or registers or other such information storage, transmission or display devices.

Computer system 200 also includes a network interface 220 coupled to the bus 202. Network interface 220 provides a two-way data communication path for computer system 200 to/from a network 222. For example, network interface 220 may be an integrated services digital network (ISDN) card or a modem to provide a data communication connection to a corresponding type of telephone line. As another example, communication interface 220 may be a LAN card to provide a data communication connection to a compatible LAN. Wireless communication links may also be implemented. In any such implementation, network interface 220 sends and receives electrical, electromagnetic or optical signals which carry digital data streams representing various types of information. In one embodiment, network 222 may be network 106, or may be communicatively coupled thereto.

FIG. 3 shows an architecture view of computer system 200. The various hardware components of computer system 200 are represented as a hardware layer 302. An operating system 304 abstracts the hardware layer and acts as a host for various applications 306a-306m, that am on computer system 200. In the case of a client computer system, the operating system also acts as a host for a Web browser application 308, while in the case of the server 104, the operating system acts as a host for a server application 310 configured to perform the processes described herein to provide training materials, on-line assessment tools, and/or individualized curricula responsive to requests and other information received from a client computer system. For the server 104, the operating system may also host a web server application 312, which provides access from the client computers via web browsers. In other instances, the web server may be hosted on a separate server (not shown in detail), which is communicatively coupled to a server hosting application 310

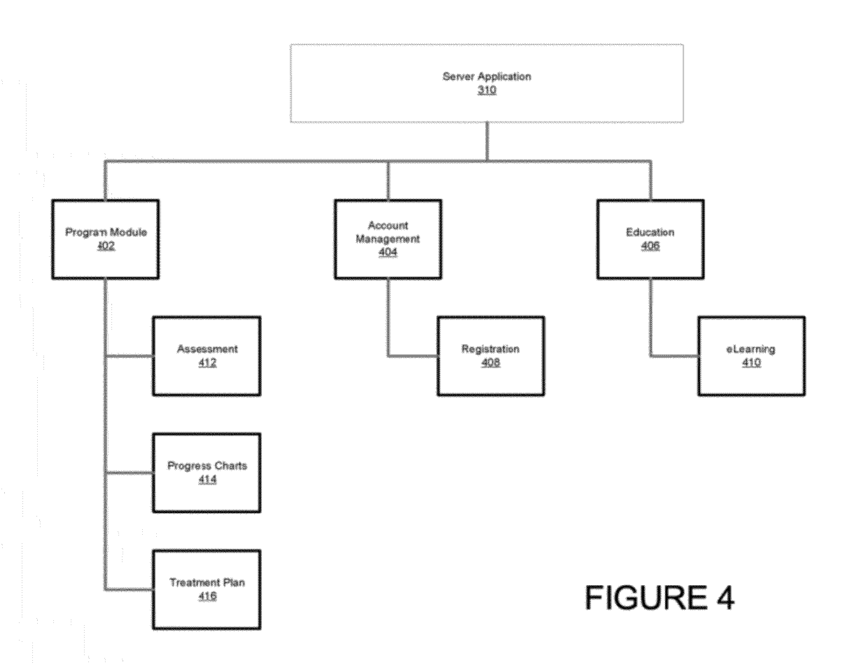

FIG. 4 provides an overview of the server-based application 310 in greater detail. The application includes a program module 402, an account management module 404, and an education module 406. Of course, other modules may also be included but are not described herein in detail so as not to distract from the salient features of the present invention. Further, in some instances, the education module 406 may not be included or may be a separate application from server application 310.

Account management module 404 includes a registration module 408. The registration module 408 allows users to set up accounts with the system, maintain user names, passwords and other information needed to access the services provided by the present system, and to establish records for various children under the tutelage or care of the user. The precise details of the registration module are not critical to the present invention.

Education module 406 includes an eLearning module 410, which provides users access to educational materials. These materials may provide training in ABA and its use in developing programs to teach skills to children with developmental disorders. Topics of such educational materials may include:
Autism and how it is diagnosed,
Introduction to ABA and its principles,
Assessment and identification of skill targets,
Teaching Paradigms, including:
   Natural Environment Training (NET),
   Discrete Trial Training (DTT),
   Fluency-Based Instruction (FBI),
Procedures discrimination training, including:
   Prompting and Fading (prompts are generally regarded as cues to encourage a desired response from an individual, and may be categorized from most intrusive to least intrusive, with a goal of teaching desired behavior to be systematic fading of prompt methods towards independence),
   Shaping (the gradual modification of existing behavior into desired behavior),
   Chaining (linking of incremental activities to be learned in order to achieve an overall desired skill),
Generalization and Maintenance (the expansion of a child's performance abilities beyond the initial conditions set for acquisition of a skill),
Functional behavioral assessment (FBA) (e.g., assessment of types and sources of reinforcement for challenging behaviors to be as the basis for intervention efforts designed to decrease the occurrence of these behaviors),
Interventions for challenging behavior (challenging behaviors are generally those which are culturally abnormal and are of such intensity, frequency or duration that the physical safety of the subject individual or others is placed in serious jeopardy, or behavior which is likely to seriously limit or deny access to the use of ordinary community facilities), and
Data collection, etc.
   The materials may be provided in any convenient fashion, for example as downloadable and/or printable documents, audio-video presentations, interactive workbooks, web-based lectures, collaborative exercises, homework assignments, etc. In some instances, the materials may be provided as part of a certification program or other formal course of instruction. For example, each of the questions posed via the questionnaire may have a related lesson of the treatment plan and a corresponding video that presents in a demonstrative fashion how to properly conduct and present the lesson to the subject individual in a manner appropriate for an autistic child.

Program module 402 includes sub-modules for child assessment 412, progress charts 414 and treatment plans 416. Collectively, these modules provide for assessing a subject child's mastered and non-mastered skills, determining a set of lessons from a specialized curriculum, which lessons define an individualized, ARA-based program of instruction (based on the needs of the subject child as identified by the assessment), and monitoring of the child's progress as he/she progresses through the lessons of the individualized program under the guidance of parents, therapists and others.

Assessment module 412 is configured to evaluate the subject child's existing skills, identifying strengths and deficits that require intervention. This is done though a question and answer interchange with the user (i.e., a behavioral educator and/or other care giver). The user answers questions concerning the child's demonstrated skills. Through those answers, skill deficits are identified, and tasks are generated and placed automatically within a task list of a treatment plan.

The question and answer interchange is divided into several stages. First, the user is presented with and is asked to answer a series of exclusionary questions. The exclusionary questions are designed to determine whether or not the subject child can perform basic skills such as speaking or bearing weight on his/her legs. These questions are thus styled for yes or no answers, and the assessment module is configured so that a “no” answer to any particular question automatically populates a “no” response for any dependent questions as well, that is, questions for which a yes answer would require the child to possess a skill inquired about in a previous question. In some instances, a “probe” answer may be submitted as a way to save the question to a temporary database table, so that, at a later time, a more detailed analysis of the question can be performed. This allows for getting the correct yes or no answer that might not be apparent when the question is first presented.

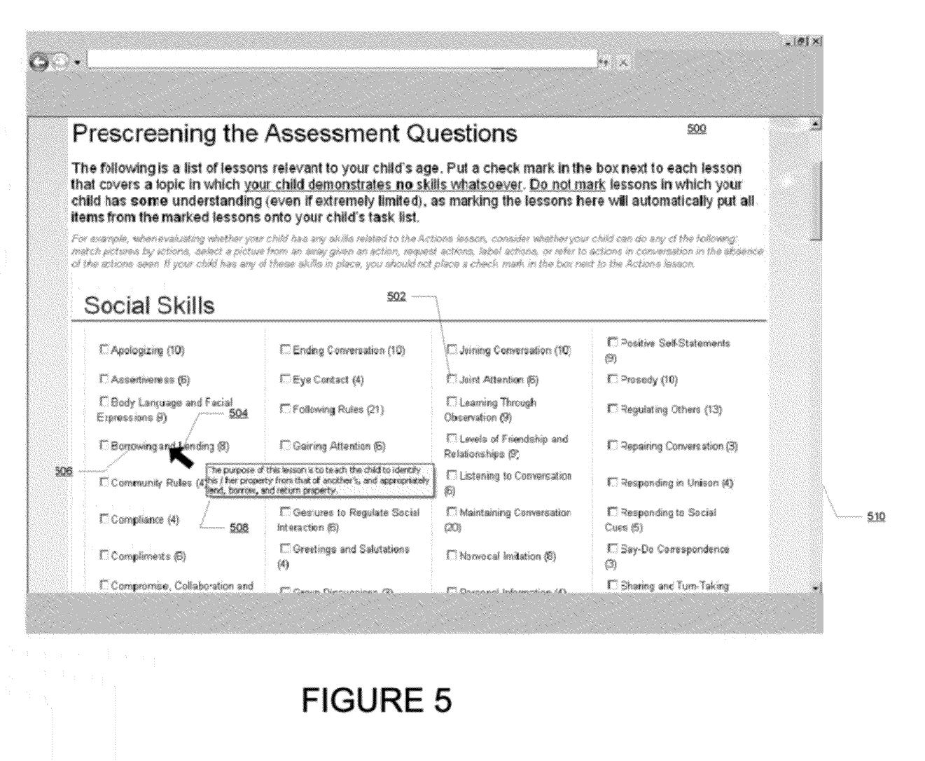

Once the user has answered the exclusionary questions, he/she then performs a “screening”. The screening is designed to obtain information concerning the subject child's current abilities with respect to a number of age-appropriate lessons. For example, and referring to FIG. 5, the screening may be performed using a web form 500 that includes a number of check boxes 502, each associated with a given lesson for a given domain. The list of lessons is selected by assessment module 412 from a number of available lessons to be relevant to the subject child's age. The user is instructed to select those check boxes next to each lesson that covers a topic in which the subject child demonstrates no skills whatsoever. Any lessons in which the subject child demonstrates some understanding (even if extremely limited), are to be left blank. If a user is unsure about the substance of a given lesson, he/she may review an explanation thereof by performing a mouse hover, that is, by placing a cursor 504 over or near a lesson description 506. In response, a hover box 508 is displayed near the cursor. The hover box includes a description of the lesson and may identity some of the associated skills which the lesson is designed to teach.

Web form 500 is an example of a user interface and in this instance is illustrated as being presented within a web browser window 510 as it may appear on the display of a user's computer system. In other instances, the user interface may be rendered within an appropriate client application window on such a computer system or mobile device. Of course, other styles of interfaces may be used to present the screening options and receive the user's response thereto, and web form 500 is merely one example of means by which the screening process may be carried out.

Once the user has entered data via the screening process, he/she may proceed to a set of skill assessment questions tailored to further determine skill deficits not specifically identified during the screening. For example, if, during the screening, the user indicated that the subject child demonstrated no skills in the area of “apologizing”, then all of the associated skill assessment questions dealing with that lesson would be automatically marked “no” and would not be presented to the user. However, if the user did not select the “apologizing” lesson during the screening, indicating that the child had at least some skills in this area, then further inquiry via the skills assessment questions directed at this lesson topic would be presented for the user to answer so that the extent of the child's skills in this area can be better assessed.

The assessment questions are preferably organized by skill area and are presented in chronological order of child development across eight domains: language, play, adaptive, motor, executive functions, cognition, social, and academic skills. Answers to the assessment questions are stored in the database (e.g., in conjunction with the child's registration information), and the program module 402 may be configured to produce reports (based on answers to the assessment questions and any subsequent updates thereto) identifying skills that are in the child's repertoire versus those that need to be taught. These reports are relevant to the child's age and may be summarized according to skills that the child's same-age peers would exhibit. As will be further described below, the treatment plan module is used to develop the individualized program of instruction that can be used by the behavioral educator to teach the subject child those skills identified as being absent from the child's repertoire.

Returning to the assessment questions, and by way of example, within the social skills domain a particular assessment question may be, “Can [child's name] use nonverbal communication to gain someone's attention when [he/she] wants an object, activity or attention?” The assessment module 412 is preferably configured to automatically populate the assessment questions with the subject child's name in the [child's name] field and to use gender appropriate pronouns. The child's gender may be determined from a gender field of a registration record stored in database 108.

As mentioned, the assessment questions are selected for presentation to the user according to the user's inputs during the screening process. Assessment module 412 includes a library of assessment questions (e.g., stored in database 108), each of which is intended to determine some fact regarding, the subject child's abilities or behaviors. To develop the question library, the present inventors determined, for each of the above-identified domains, a set of assessment items and assigned those assessment items to lesson topics (from which lesson names are derived). Within each lesson topic, the inventors examined developmental ages of skills and used that information to determine lesson areas. The skill assessment questions are based on the particular skills the child should exhibit for each lesson area.

In addition to the skill assessment question, the user may be provided with an explanation of what a yes or no answer to the question means and/or with an example of the activity or skill being inquired about. For example, in the case of the above question concerning nonverbal communication, the user may be notified that the question seeks to determine whether the child can perform actions such as holding or tugging on an individual's hand, reaching towards a desired object while making eye contact with that individual, and/or leading the individual to the desired object.

In practice, the skill assessment questions (and any related explanations) may be presented via a Web browser running on the user's computer and the user is preferably provided with means (e.g., graphical selection means, which may be selected using a cursor control device and/or keyboard keys) for indicating a yes or no (or, optionally, unknown/unsure) answer. The answers to the skill assessment questions are stored in database 108 in conjunction with other records for the child, and the user (i.e., the person or persons answering the questions) may be provided with a visual indication of the user's progress through the entire question hank (e.g., on a question-by-question and/or domain-by-domain basis, etc.).

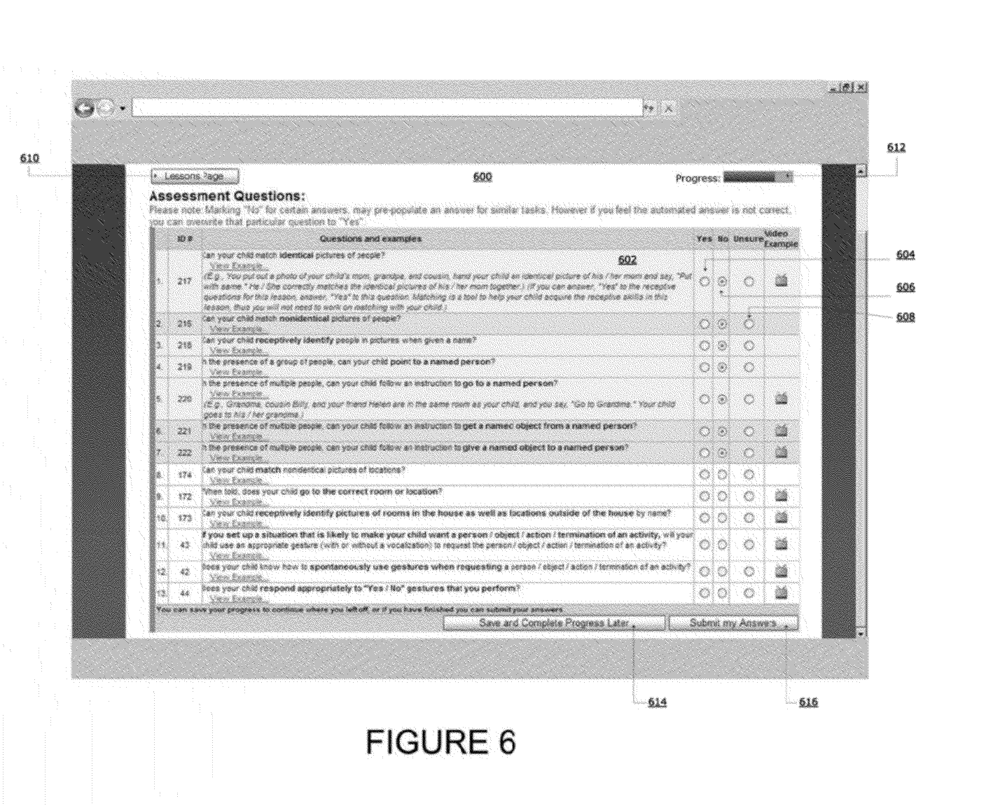

FIG. 6 illustrates an example of a user interface 600 for the presentation of skill assessment questions and obtaining responses thereto, in accordance with an embodiment of the present invention. The questions and any amplifying or clarifying information (including, but not limited to, textual and/or video clips highlighting examples of the behavior being inquired about and/or the behaviors addressed by the lessons linked to the questions, which information and/or clips may be stored in the database) are presented within a question window 602, and the user is provided with buttons 604, 606, 608 or other graphical elements through which an answer may be indicated. In this example, buttons are provided for yes (604), no (606) and unsure (608) answers, but other response options may be provided in addition to or in lieu of these options.

Through the use of a drop down menu 610 or other user interface feature, the user is provided means for navigating to different domain question areas, and the overall progress through the set of exclusionary questions (or a domain set thereof) may be indicated using a progress bar 612 or other means. Users can complete the questionnaire in one or more sessions and to accommodate this latter instance a facility is provided for users to save their answers prior to submitting a completed assessment. As shown in the illustration, this may be done by selecting a user interface element such as button 614, labeled to alert the user that the state of an in-progress session (i.e., current answers to the questions) may be saved to database 108 by selecting (e.g., via, a mouse click operation) the button. When the user has completed an assessment (e.g., by answering all of the questions that can currently be answered), the assessment may be “submitted” through selection of button (or other user interface element) 616. This results in the answers being saved to database 108.

Above, it was noted that the skill assessment questions are based on the particular skills the child should exhibit for each lesson area. In the context of an instructional program in order to teach a set of skills to a child, an instructor introduces a set of discriminative stimuli and/or establishing operations (EO). Each discriminative stimulus (S^{D}) is, typically, an instruction or request to which the instructor would like the child to respond (R) (e.g., by exhibiting a particular behavior). An EO is an environmental event that affects the child by momentarily altering (a) the reinforcing effectiveness of other events and (b) the frequency of occurrence of that part of the child's repertoire relevant to those events as consequences. Both EOs and S^{D}s are intended to evoke behavioral responses in the child. More particularly then, the skills assessment questions are tailored to each S^{D} and/or EO in a lesson.

In some embodiments of the invention, each skill assessment question may be regarded as pertaining to either a building block, a fundamental skill, or an expansion skill. Building blocks are components of behavioral development that are not fundamental skills in themselves but may be useful prerequisites for one or more fundamental skills. Fundamental skills are the central milestones of psychological/behavioral/educational human development, and are necessary for successful daily functioning. Expansion skills constitute higher-order fine-tuning of fundamental skills and may not always be essential to core human functioning. The skill assessment questions may be presented to the user in a hierarchical fashion, e.g., by lesson name, then lesson area, then question type (i.e., direct to building blocks, fundamental skills, or expansion skills). Fundamental skills are at the top of the hierarchy within each lesson area and the associated skill assessment questions may be presented accordingly. Skill assessment questions relating to building blocks and expansion skills may be hidden (at least initially) or may be shown underneath those relating to the fundamental skills. In this way, a user need only answer skill assessment questions that are associated with fundamental skills. If the user answers “yes” to all the questions directed to fundamental skills within a lesson area, the questions relating to the building blocks for those fundamental skills are automatically set as “yes”. If the user answers “no” to any of the questions directed to fundamental skills within a lesson area, the user must then also answer the questions directed to the building blocks within the lesson area. Further, whenever a question directed to a fundamental skill is answered as “no”, other skills that require that skill in order to be performed are automatically answered as “no”. Regardless of how the user answers questions directed to fundamental skills, those questions directed to expansion skills may always be presented for answers. In some instances, where questions may be answered as “unknown” or “unsure”, such answers will be treated as “no” answers in the sense that the associated skills will be presented for inclusion in a treatment plan.

Within the format of the above-described hierarchy, questions from the question library may be presented in an order determined by level of difficulty and age of the child. In one embodiment of the present invention, each domain is divided into 12 difficulty levels. If the subject child is 3 years 8 months, the skill assessment questions presented to the user will start at level 1 and will include only questions appropriate for children aged 0-4 years.

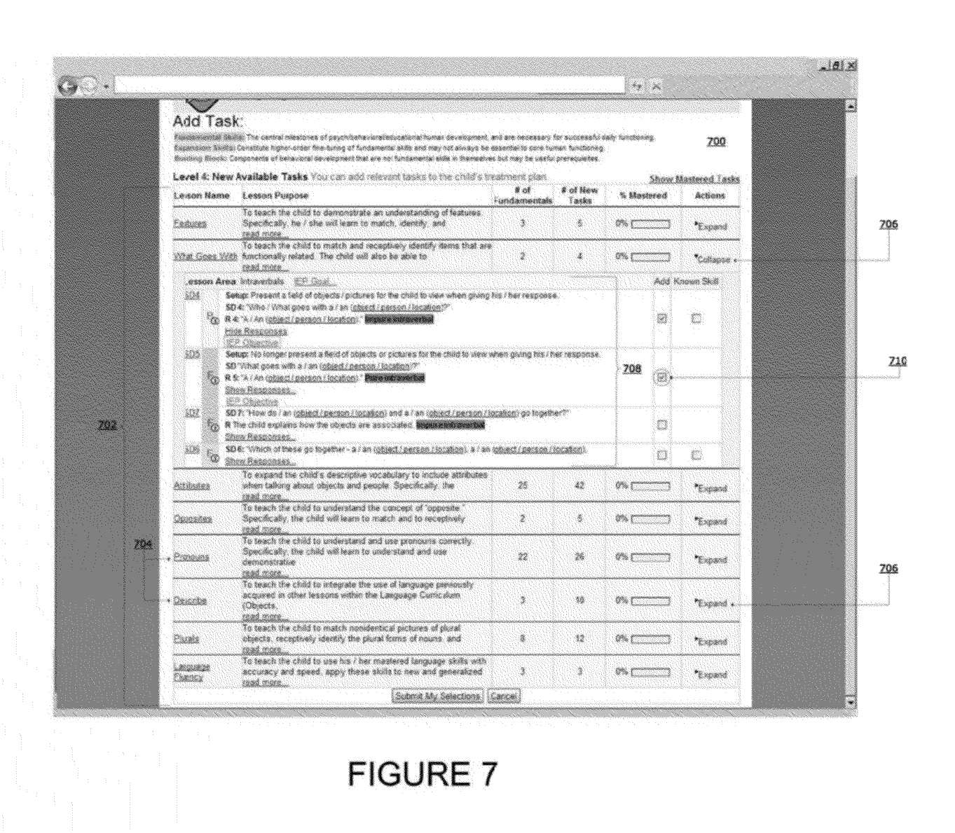

The treatment plan module 416 provides a workspace for a user to build an active treatment plan using the skill targets identified though the skills assessment questions. In this context, a treatment plan is a series and sequence of age-appropriate tasks FIG. 7 illustrates an example of a user interface 700 for building a treatment plan in accordance with an embodiment of the present invention.

Within user interface 700 are displayed current, or active, treatment recommendations 702. The treatment recommendations collectively define a treatment plan, which is made up of individual lessons 704. The lessons may be coded in the context of an associated S^{D} and/or EO (for simplicity, hereinafter only the term S^{D} will be used, but it should be understood that the use of this term encompasses both S^{D} and EO). A user interface element (e.g., an “expand” link) 706 is provided to allow a user to add lessons to the treatment plan. When element 706 is selected (e.g., by way of a cursor control event such as a mouse click), a task list 708 is presented. The task list is a teaching level sorted list of the lessons deemed necessary for the subject child, based on the answers to the skill assessment questions. Lessons that are associated with assessment questions that were answered “no” or “unsure” are automatically added to the task list 708. When the associated skill is mastered (as determined from progress updates provided by the therapist), the lesson is removed from the task list. Within the task list, the lessons are presented in a suggested teaching order, according to difficulty level and age criteria, as discussed below. Selecting a lesson from the task list, for example using check box 710, promotes the associated lesson into the treatment plan 702.

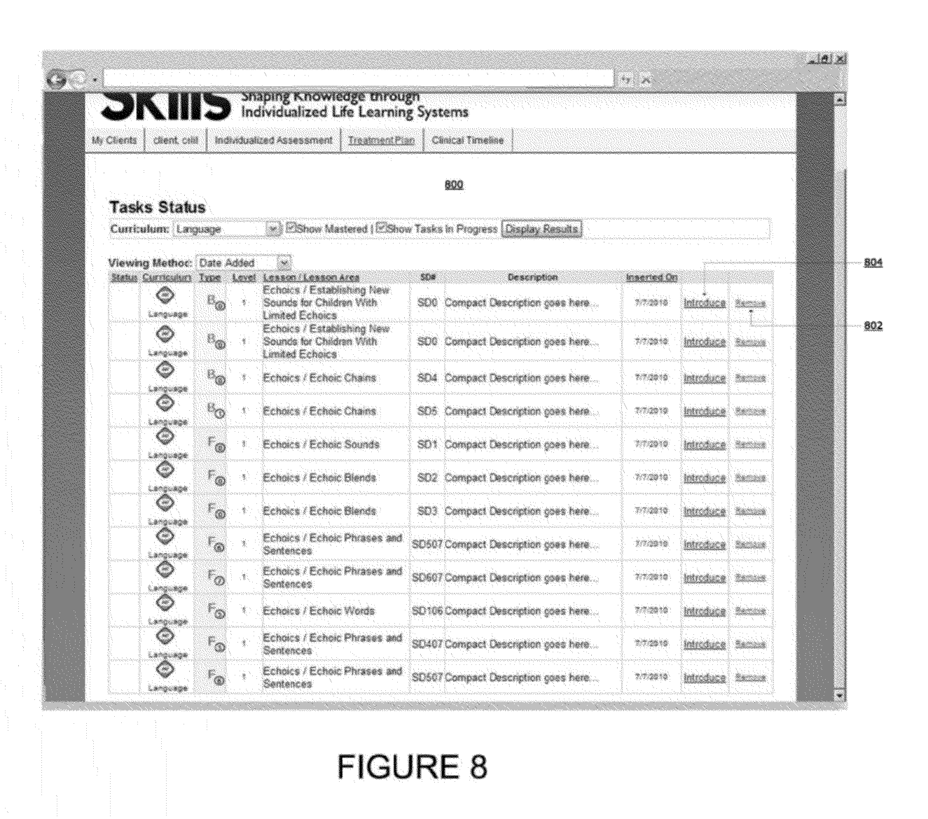

Referring to FIG. 8, task status can be reviewed through a user interface 800. Using this view, individual lessons can be removed from a treatment plan by selecting a “remove” element 802. Further, lesson content can be initiated or introduced using “introduce” element 804. Although shown as links, these elements 802, 804, may be buttons or other convenient user interface elements, as desired.

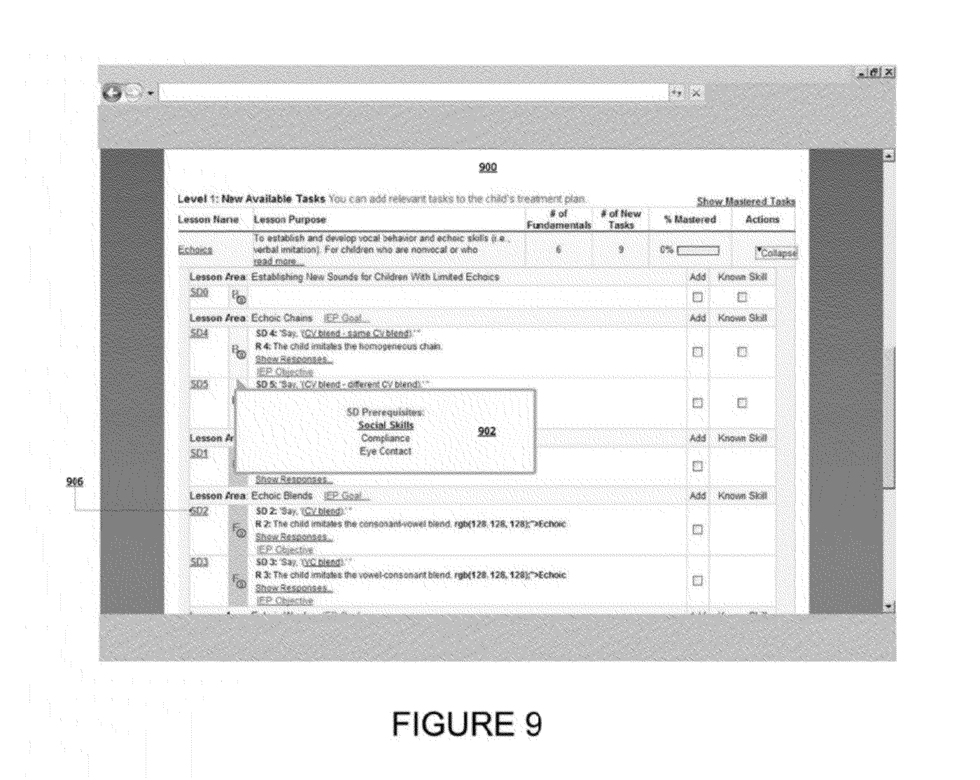

FIG. 9 shows an expanded view of a task list 900. In response to a mouse over of a linked area 906 of a lesson in the task list, details regarding that lesson may be provided in a pop-up window 902. Among the details so provided may be the lesson name, the curriculum domain within which the lesson is provided, the skill targeted by the lesson, age-related information regarding the target skill (e.g., the kind of behavior expected by a child of a certain age within the context of the target skill), prerequisites for the lesson, and individualized education plan (IEP) goals of the lesson.

IEPs, which are mandated in some countries, are written plans specifying information such as a child's present level of functioning, specific areas that need special services, annual goals, short-term objectives, services to be provided, and the method of evaluation to be implemented for the child. The present invention helps simplify the task of creating IEPs by including directly within each lesson a defined IEP goal. If a user decides to place a particular lesson into a child's treatment plan, the treatment plan module will automatically place the associated IEP goals and objectives into an IEP report, which can be later viewed, edited and printed by the user. That is, IEP goals are automatically identified and used to populate an IEP task list for use in IEP planning and implementation. Specific IEP example goals may be assigned to each S^{D}/EO task to help facilitate this planning and implementation. The linking of IEP intelligent suggestions is thus made possible by the data derived from the skills assessment process facilitated by the present invention IEP goals are retained for every S^{D}/EO within the system, allowing for automated planning to address the specific deficiencies of the assessed individual.

With the present system then, each area of human functioning is addressed through the eight content areas or domains. Each content area is segregated into multiple teaching programs, and each program is divided into multiple specific lessons in order to address specific skill deficiencies identified during a comprehensive assessment. Collectively, the selected lessons comprise a treatment plan, within which the lessons are arranged in the order in which they emerge in typical child development.

In order to ensure that the skills which the lessons are intended to teach are introduced in the proper (or recommended) order, a system of levels has been devised. This allows a detailed treatment plan for each domain to be developed; i.e., one in which lesson areas are segregated by level and individual skills within each lesson area are segregated by age.

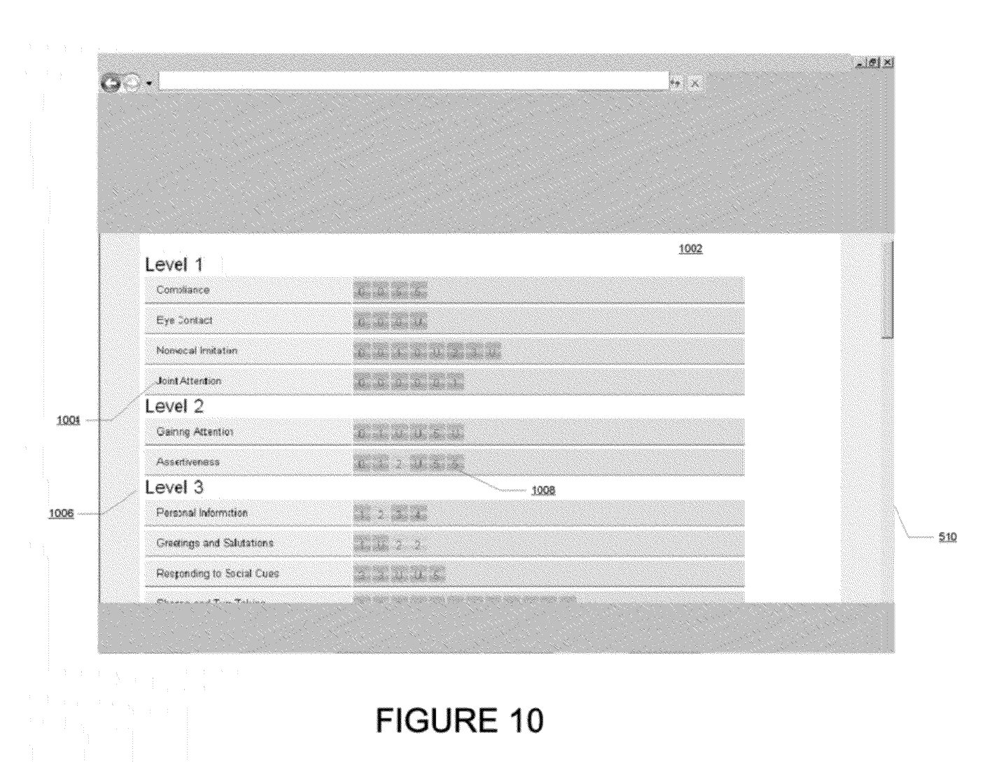

Referring to FIG. 10, an example of such a detailed treatment plan 1002, for a particular domain, is shown. This sort of detailed treatment plan may be presented as part of a progress chart by progress chart model 414, and is developed according to the lessons selected for inclusion in the treatment plan, in the fashion discussed above. The detailed treatment plan includes all of the selected lesson areas (e.g., compliance, eye contact, greetings and salutations, etc.) 1004 segregated, along a first treatment plan axis, into levels 1006, with each lesson area segregated, along a second treatment plan axis, into individual skills 1008. Each skill of a lesson area has at least one corresponding assessment question from the assessment module. The skills of each lesson area are coded (e.g., by color or otherwise) according to whether or not the subject child has already mastered that skill (as determined by the user's answers to the associated assessment question and/or later progress updates), and further age (i.e., the age group at which a typical child masters the skill). Ages are represented as 0 for age 0-1, 1 for age 1-2, etc., and only those skills appropriate to the subject child's age are populated within the detailed treatment plan.

Because each lesson area begins with skills that are more easily mastered and then includes those which are more difficult to master, the skills are not necessarily introduced into the treatment plan in order by number (i.e., in a linear progression). For example, for a given lesson area, in order to follow a recommended treatment plan one might introduce skill #1, then skill #2, then skill #5, then skill #6, then skill #3, etc.

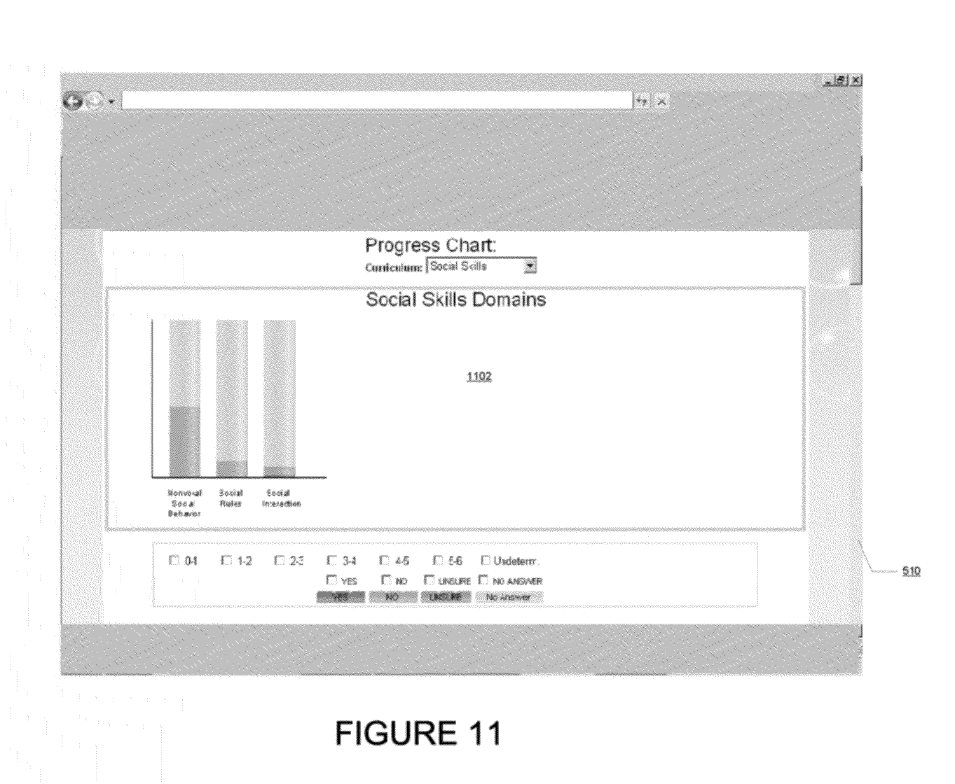

Overall, to implement the treatment plan, a therapist would introduce the first skills within all the lesson areas of level 1, then progress to other skills. To help ensure that the skills are introduced in a recommended order, the associated lesson plans for each skill specify prerequisites; i.e., skills which the subject child should possess (have mastered) before trying to teach the skill that is the subject of the lesson. Further, domain-level progress charts 1102 (see FIG. 11) assist the therapist in gauging where the subject child is progressing and which skills to teach next. Timeline charts of this nature, showing progress through skill mastery, may also be presented. Note that in some cases, prerequisite skills may refer to skills from domain areas other than a current domain area. In this way, the treatment plan spans multiple domains, allowing for a more holistic approach to the child's training.

The individual lesson plans may be made available for review via a computer display, download and/or printing through selection from the detailed treatment plan or elsewhere. For example, selecting a skill from a detailed treatment plan may cause the user's browser to open a new tab or window in which the associated lesson plan is presented. The lesson plans may include examples of stimuli that the supervisor/therapist can introduce. In addition, worksheets for the subject child may be included. In some embodiments, the lesson plans are interactive, allowing the user to customize the lesson plan to the subject child receiving the instruction.

The lesson plan may be divided into sections, including milestones that are relevant to the subject child's chronological age or younger. However, the user may also be able to view future milestones so that he/she is able to plan for the child's future curriculum and to ensure that the user does not attempt to teach age-inappropriate skills.

The lesson plans generally follow a pattern of indicating a target response from the child and then suggesting an S^{D})/EO to obtain the desired response, or vice versa. For example, a lesson may read:
S^{D}: The therapist presents a field of comparison objects, hands the child a sample object, and presents the vocal stimulus, “Put with same”.
R: The child matches the sample object to an identical object in the field. In some instances, a lesson plan may include EOs (which describe the child's state as it relates to motivation) and SDs; for example:
EO: The child is deprived of a desired object.
S^{D}: The therapist contrives a situation that evokes the child to mand for a desired object.
R: “More” or “More (object)” or “(Object)” or “I want (object),” with/without a gesture toward the desired object.
   A mand is a form of verbal behavior that is controlled by deprivation, satiation, or what is now called motivating operations (MO), as well as a controlling history.

In other cases, the lesson plan may specify a set up; for example:
Setup: Present a field of pictures of locations for the child to view when giving his/her response
S^{D}: “Where do you go to (action)?”
R: “A/A/The (room/location).”

The Setup, EO, S^{D}, and R are all editable by the user, allowing the user to modify the lesson to suit a particular child's needs. For example, for a child who cannot point, the SD “Touch (object)” could be changed to “Give me (object)”. For a child who might use a different response (e.g., a non-vocal child as opposed to a vocal child), the R could be changed from “(Object)” to handing over a picture of the object. Thus, the lesson plan has the ability for the user to make these kinds of changes.

As is shown in the examples of EOs, S^{D}s, and Rs above, the user is also able to customize what is presented to the child using “plug-ins”. For example, in the SD: “Where do you go to (action)?” The part in parentheses and underlined is the “plug-in”. It is intended that the user insert the name of different exemplars of “actions” into the S^{D}. In some cases, for an on-line version of the lesson plan and in response to a user input, a user may be presented with a list of exemplars (i.e., in this case, a list of different actions) which can be used. Some SDs have multiple plug-ins. Thus, users will be able to choose the exemplars they want for each plug-in. Once exemplars are chosen, the user may be provided with a printable list.

As indicated above, the lesson plans may be interactive, allowing a user to customize the manner in which the subject: child will receive instruction. For example, a user may customize a prompting hierarchy specified within a lesson plan. This may be done by presenting the user with selectable choices for a prompt fading procedure to be employed and for the prompts to be used. Such choices may be presented through drop down lists, tables with check boxes or radio buttons, or via other means. Selectable prompt fading procedures may include most-to-least and least-to-most. The selectable prompts may include:
Full physical,
Partial physical,
Model Demonstration,
Full echoic,
Partial echoic,
Full directive,
Partial directive,
Receptive,
Textual,
Gestural,
Proximity,
Voice inflection,
Stimulus manipulation,
_second time delay to (prompt), and
(create your own prompt):
   where, if “_second time delay to (prompt)” is selected, the user is to determine the number of seconds to delay until a prompt is given as well as what prompt should be delivered. Any of the above-specified prompts may be used in the “(prompt)” field. The user can also create his/her own prompts by clicking on “(create your own prompt)”.

The lesson plans may also include a section for “Teaching Options”, which allow the user to specify individual variations for teaching a particular skill. In an interactive lesson plan, this field may be user-editable and any such edits may be saved in the context of the lesson plan for later use and/or reference. Further, lesson plans may include teaching points that provide hints, troubleshooting ideas, things to consider and to watch out for while teaching a particular skill. These teaching points may be provided by way of a user-editable field in the lesson plan and any such edits may be saved in the context of the lesson plan for later use and/or reference. Each lesson plan also provides milestones associated with the target S^{D} and R, allowing the user to determine what children of typical development are able to perform within the S^{D} of concern.

A generalization field in the lesson plans may provide ideas for ensuring that the subject child is able to use the skills, once learned, across different stimuli (i.e., teaching materials and variations of the instruction). It may also provides ideas for ensuring that the child does not use one rote response but is able to use variations in his/her response that would also be considered correct. This section may be user-editable and any such edits may be saved in the context of the lesson plan for later use and/or reference.

A cross reference field within a lesson plan may provide the names of other lessons and skill areas that target similar or related skills as to the one being targeted in a current lesson plan, if the lesson being, cross referenced is in the child's age range and the user has already answered skills assessment questions regarding the lesson area, the user is able to link to the cross-referenced lesson area within the current lesson plan to read more about it. If the lesson being cross referenced is in the child's age range and the associated assessment question(s) has/have not yet been answered, the user may be prompted to answer those questions so that he/she can view the cross-referenced material.

From the foregoing, it should be apparent that several advantages are afforded by the present invention. For example, the 1:1 correspondence between the assessment questions and the lesson curriculum means that educators and others need not speculatively interpret assessment results in an effort to decide which skills to introduce into a treatment plan. Additionally, dependencies between questions are coded so that a user need not answer any questions for skills that are dependent on other questions that have already been answered. Further, the segregation of lesson areas within a curriculum by varying level of difficulty and the identification of prerequisite skills allows users to develop treatment plans on an S^{D}-by-S^{D} basis in a recommended order, while still retaining flexibility to customize such plans for individual students. IEP reports with IEP goals and objectives are produced automatically when a treatment plan is constructed.

Thus, computer-based methods and systems for providing behavioral educators of children with developmental disorders: (a) training in ABA and how it is used to teach skills to said children, (b) on-line assessment tools to identify mastered and non-mastered skills of said children, and (c) automatically generated and individualized ABA-based programs of instruction based on the needs of said children as identified through use of the assessment tools have been described. As has been noted above, embodiments of the present invention may be implemented with the aid of computer-implemented processes or methods (a.k.a. programs or routines). These processes may be rendered in any computer-readable language including, without limitation, C#, C/C++, Fortran, COBOL, PASCAL, assembly language, markup languages (e.g., HTML, SGML, XML, VoXML), and the like, as well as object-oriented environments such as the Common Object Request Broker Architecture (CORBA), Java™ and the like. In general, however, all of the aforementioned terms as used herein are meant to encompass any series of logical steps performed in a sequence to accomplish a given purpose.

What is claimed is:

1. A computer-based system, comprising: a processor and a storage medium communicatively coupled to said processor, said storage medium storing instructions, which when executed by said processor cause said processor to execute a program module configured with sub-modules for assessing development of a subject individual, presentation of progress charts and development of individualized treatment plans, wherein
an assessment sub-module of the program module includes assessment tools for behavioral educators to identify mastered and non-mastered skills of a subject individual, said assessment tools including a question and answer interchange mechanism configured to permit evaluation of the subject individual's existing skills, identifying strengths and deficits that require intervention, said question and answer interchange mechanism organized as a preliminary exclusionary questionnaire designed to determine whether or not the subject individual can perform basic skills, a screening process designed to obtain information concerning the subject individual's current abilities with respect to a number of age-appropriate lessons, and a detailed set of skill assessment questions based on particular skills the subject individual should exhibit for each of a number of lesson areas and tailored to further determine skill deficits of the subject individual not specifically identified during the screening process, wherein through answers provided via the assessment tools, skill deficits of the subject individual are identified, and tasks are generated and placed automatically within a task list of a treatment plan sub-module;
the treatment plan sub-module of the program module is configured to permit the behavioral educator to determine a set of domain-sorted lessons from a proposed task curriculum, which lessons define an individualized, Applied Behavior Analysis (ABA)-based program of instruction based on the needs of the subject individual as identified by the assessment tools to teach the subject individual skills identified as being absent from the subject individual's repertoire according to answers to the skill assessment questions, and
a progress chart sub-module of the program module is configured to permit monitoring of the subject individual's progress as the subject individual progresses through the lessons of the individualized program under the guidance of one or more instructors.

2. The computer-based system of claim 1, wherein the skill assessment questions are organized by skill area and are presented to a user in chronological order of development across a plurality of domains.

3. The computer-based system of claim 2, wherein the domains comprise language, play, adaptive, motor, executive functions, cognition, social, and academic skills.

4. The computer-based system of claim 1, wherein the program module is configured to produce reports based on answers to assessment questions identifying skills that are in the subject individual's repertoire versus those that need to be taught, and the reports are configured to be age-relevant and summarized according to skills that the subject individual's same-age peers would exhibit.

5. The computer-based system of claim 1, wherein each of the skills assessment questions are tailored to particular discriminative stimulus (S^{D}) and/or establishing operations (EO) of a respective one of a plurality of lessons of the individualized program of instruction.

6. The computer-based system of claim 5, wherein the assessment sub-module is configured to present the skills assessment questions to a user in a hierarchical fashion, by lesson name, then lesson area, then question type.

7. The computer-based system of claim 6, wherein the assessment sub-module is configured such that a “yes” answer to a skills assessment question directed to a fundamental skill within a lesson area will automatically populate “yes” answers to any questions directed to prerequisite skills for the fundamental skill, however, a “no” answer to the fundamental skill will automatically populate “no” answers to questions directed to other skills that require the fundamental skill in order to be performed.

8. The computer-based system of claim 1, wherein the program module is configured to present a detailed treatment plan developed according to individual lessons selected for inclusion in the individualized program of instruction, said detailed treatment plan including lessons from one or more selected lesson areas and being segregated along a first treatment plan axis into levels, each lesson area being so segregated, and a second treatment plan axis into individual skills.

9. A computer-implemented method, comprising:
assessing, based on answers to questions posed via a questionnaire presented to a user via a client computer system communicatively coupled to a server, a subject individual's autism-related disorders;
identifying, based on said assessing, mastered and non-mastered skills of the subject individual; and
producing an individualized treatment plan for the subject individual to address the non-mastered skills of the individual,
wherein each of the questions addresses a specific skill needed by the subject individual and the answers to the questions are submitted as a “yes”, a “no”, or “probe”, each of the questions is designed to identify a specific skill deficiency of the subject individual, and each skill deficiency of the subject individual is accounted for in an age-appropriate lesson of the treatment plan for the subject individual, at least some of the lessons encompassing individualized education plan (IEP) goals, said IEP goals being automatically placed in an IEP task list for IEP planning and implementation.

10. The computer-implemented method of claim 9, wherein progress of the subject individual through mastery of skills addressed by lessons of the treatment plan is presented in graphical form along with statistical charts displaying time and numerical trial indicators.

11. The computer-implemented method of claim 10, wherein mastery of a skill is reported to a level of individual, user-editable exemplars, and at an overall lesson level.

12. The computer-implemented method of claim 10, wherein mastery of a skill is reported via graphical representations displayed to a user, said reporting facilitated by linkage of the questions and the lessons.

13. The computer-implemented method of claim 9, wherein each of the questions posed via the questionnaire has a related lesson of the treatment plan and a corresponding video that presents in a demonstrative fashion how to properly conduct and present the lesson to the subject individual in a manner appropriate for an autistic child.
